(19) United States
(12) Patent Application Publication
(10) Pub. No.: US 2026/0034790 A1
(43) Pub. Date: Feb. 5, 2026

(54) LIQUID SUPPLY MEMBER, LIQUID DISCHARGE HEAD, AND RECORDING DEVICE

(71) Applicant: KYOCERA Corporation, Kyoto (JP)

(72) Inventors: Naoto MIYAKOSHI, Osaka-shi, Osaka (JP); Masaru IWABUCHI, Kirishima-shi, Kagoshima (JP)

(21) Appl. No.: 18/998,519

(22) PCT Filed: Jul. 28, 2023
(86) PCT No.: PCT/JP2023/027831

§ 371 Date: Jan. 27, 2025

(30) Foreign Application Priority Data
Jul. 28, 2022 (JP) 2022-120412

(51) Int. Cl. B41J 2/175; B41J 2/165; B41J 25/34; B41J 29/377

(52) U.S. Cl. CPC B41J 2/175; B41J 2/16508; B41J 25/34; B41J 29/377

(57) ABSTRACT

A liquid supply member includes a first member, a second member, a channel, a joint, an opening, and a dam. The channel is located between the first member and the second member. The joint is located at an interface between the first member and the second member and surrounds the channel. The opening communicates with an inside of the liquid supply member. The dam is located between the opening and the outside.

### TECHNICAL FIELD

The disclosed embodiments relate to a liquid supply member, a liquid discharge head, and a recording device.

### BACKGROUND OF INVENTION

Inkjet printers and inkjet plotters utilizing an inkjet recording method are known as printing devices. A liquid discharge head for discharging a liquid is mounted in such a printing device that uses an inkjet method.

Such a liquid discharge head includes, for example, a discharge member that discharges a liquid, and a liquid supply member that supplies the liquid to the discharge member. The liquid supply member may be made such that a channel is formed between two members adjacent to each other and then the two members are joined to each other by welding or the like.

### CITATION LIST

### Patent Literature

Patent Document 1: JP 2011-79244 A

### SUMMARY

A liquid supply member according to an aspect of an embodiment includes a first member, a second member, a channel, a joint, an opening, and a dam. The channel is located between the first member and the second member. The joint is located at an interface between the first member and the second member and surrounds the channel. The opening communicates with an inside of the liquid supply member. The dam is located between the opening and the outside.

### BRIEF DESCRIPTION OF THE DRAWINGS

FIG. 1 is a front view schematically illustrating an overall front of a printer according to an embodiment.

FIG. 2 is a plan view schematically illustrating an overall plane of the printer according to the embodiment.

FIG. 3 is a perspective view illustrating an example of a schematic configuration of a liquid discharge head according to the embodiment.

FIG. 4 is a partially enlarged perspective view of the liquid discharge head illustrated in FIG. 3.

FIG. 5 is a perspective view illustrating an example of a channel member according to the embodiment.

FIG. 6 is a partially enlarged perspective view of the channel member illustrated in FIG. 5.

FIG. 7 is a view for explaining a dam according to the embodiment.

FIG. 8 is a perspective view illustrating an example of a liquid supply member according to the embodiment.

FIG. 9 is a cross-sectional view for explaining an example of a lid-like member according to the embodiment.

FIG. 10 is a perspective view illustrating another example of the channel member according to the embodiment.

### DESCRIPTION OF EMBODIMENTS

In the above-described liquid supply member, for example, ink may enter the inside, causing a short circuit of wiring or the like, and thus there is room for further improvement in terms of enhancing reliability.

Provision of a liquid supply member, a liquid discharge head, and a recording device having high reliability is expected.

Embodiments of a liquid supply member, a liquid discharge head, and a recording device disclosed in the present application will be described below with reference to the accompanying drawings. Note that the present disclosure is not limited to the embodiments described below. Note that the drawings are schematic and that the dimensional relationships between elements, the proportions of the elements, and the like may differ from the actual ones. There may be differences between the drawings in terms of dimensional relationships and proportions.

In the following embodiments, expressions such as “constant”, “orthogonal”, “perpendicular”, and “parallel” may be used, but these expressions need not mean exactly “constant”, “orthogonal”, “perpendicular”, and “parallel”. In other words, it is assumed that the above expressions allow for deviations in manufacturing accuracy, installation accuracy, or the like.

Embodiments can be appropriately combined so as not to contradict each other in terms of processing content. In the following embodiments, the same portions are denoted by the same reference signs, and redundant explanations are omitted.

### Embodiment

### Configuration of Printer

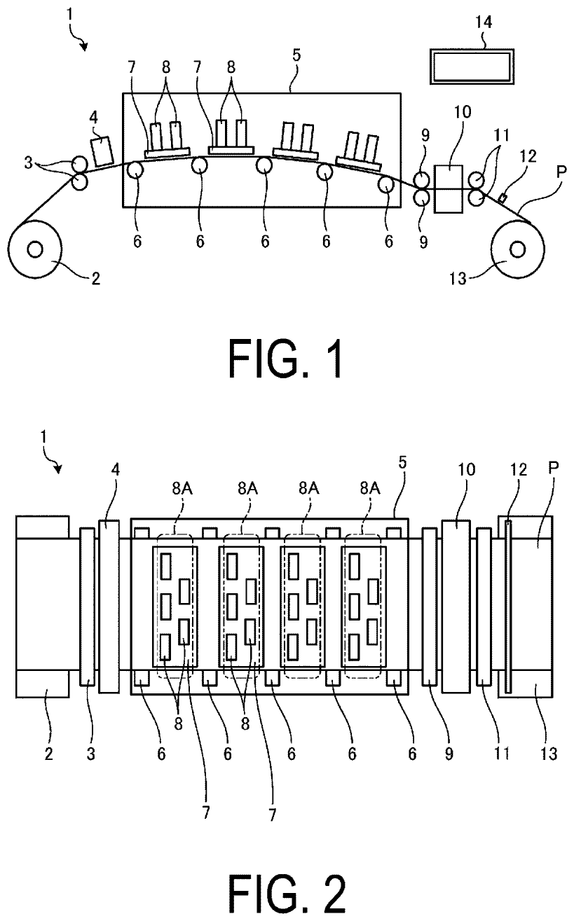

With reference to FIGS. 1 and 2, an overview of a printer is described as an example of a recording device according to an embodiment. FIG. 1 is a front view schematically illustrating an overall front of the printer according to the embodiment. FIG. 2 is a plan view schematically illustrating an overall plane of the printer according to the embodiment. The printer according to the embodiment is, for example, a color inkjet printer.

As illustrated in FIG. 1, a printer 1 includes a paper feed roller 2, guide rollers 3, an applicator 4, a head case 5, a plurality of transport rollers 6, a plurality of frames 7, a plurality of liquid discharge heads 8, transport rollers 9, a dryer 10, transport rollers 11, a sensor 12, and a collection roller 13. The transport roller 6 is an example of a transporter.

The printer 1 further includes a controller 14 configured to control each portion of the printer 1. The controller 14 controls operations of the paper feed roller 2, the guide rollers 3, the applicator 4, the head case 5, the plurality of transport rollers 6, the plurality of frames 7, the plurality of liquid discharge heads 8, the transport rollers 9, the dryer 10, the transport rollers 11, the sensor 12, and the collection roller 13.

By depositing droplets on a printing sheet P, the printer 1 records images and characters on the printing sheet P. The printing sheet P is an example of a recording medium. The printing sheet P is rolled on the paper feed roller 2 prior to use. The printer 1 transports the printing sheet P from the paper feed roller 2 to the inside of the head case 5 via the guide rollers 3 and the applicator 4.

The applicator 4 uniformly applies a coating agent over the printing sheet P. Accordingly, a surface treatment can be performed on the printing sheet P, and the printing quality of the printer 1 can thus be improved.

The head case 5 houses the plurality of transport rollers 6, the plurality of frames 7, and the plurality of liquid discharge heads 8. The inside of the head case 5 is formed with a space separated from the outside except for portions connected to the outside such as portions from which the printing sheet P enters and exits the head case 5.

The controller 14 controls at least one of controllable factors of the internal space of the head case 5, such as temperature, humidity, and air pressure, as necessary. The transport rollers 6 transport the printing sheet P to the vicinity of the liquid discharge heads 8 inside the head case 5.

The frames 7 are rectangular flat plates and are positioned above and in close proximity to the printing sheet P transported by the transport rollers 6. As illustrated in FIG. 2, the frames 7 are located such that a longitudinal direction is orthogonal to a transport direction of the printing sheet P. The plurality of frames 7 (e.g., four frames) are located at predetermined intervals along the transport direction of the printing sheet P in the head case 5.

A liquid, for example, ink, is supplied to the liquid discharge head 8 from a liquid tank (not illustrated). The liquid discharge head 8 discharges the liquid supplied from the liquid tank.

The controller 14 controls the liquid discharge heads 8 based on data of an image, characters, or the like to discharge the liquid toward the printing sheet P. A distance between each of the liquid discharge heads 8 and the printing sheet P is, for example, approximately 0.5 mm to 20 mm.

The liquid discharge heads 8 are fixed to the frames 7. The liquid discharge heads 8 are located such that the longitudinal direction is orthogonal to the transport direction of the printing sheet P.

In other words, the printer 1 according to the present embodiment is a so-called line printer in which the liquid discharge heads 8 are fixed inside the printer 1. Note that the printer 1 according to the present embodiment is not limited to the line printer and may also be a so-called serial printer.

The serial printer is a printer employing a method of alternately performing an operation of recording while moving the liquid discharge heads 8 such that the liquid discharge heads 8 reciprocate in a direction intersecting, for example, substantially orthogonal to the transport direction of the printing sheet P, and an operation of transporting the printing sheet P.

As illustrated in FIG. 2, a plurality of liquid discharge heads 8 (e.g., five liquid discharge heads) are fixed to one frame 7. FIG. 2 illustrates an example in which three liquid discharge heads 8 are located on the front side and two liquid discharge heads 8 are located on the rear side, in the transport direction of the printing sheet P. The liquid discharge heads 8 are located such that their centers do not overlap in the transport direction of the printing sheet P. The plurality of liquid discharge heads 8 located in one frame 7 form a head group 8A. Four head groups 8A are located along the transport direction of the printing sheet P. The liquid discharge heads 8 belonging to the same head group 8A are supplied with four colors of ink. As a result, the printer 1 can perform printing with four colors of ink by using the four head groups 8A.

The colors of the ink discharged from the respective liquid discharge heads 8 are, for example, magenta (M), yellow (Y), cyan (C), and black (K). The controller 14 can print a color image on the printing sheet P by controlling the respective liquid discharge heads 8 to discharge the plurality of colors of ink onto the printing sheet P.

Note that a coating agent may be discharged from the liquid discharge heads 8 onto the printing sheet P to perform a surface treatment on the printing sheet P.

The number of the liquid discharge heads 8 included in one of the head groups 8A and the number of the head groups 8A mounted in the printer 1 can be changed as appropriate in accordance with an object to be printed and printing conditions. For example, the number of the liquid discharge heads 8 mounted in the printer 1 may be one when it is desired to print a printable area that can be printed with one liquid discharge head 8.

The printing sheet P on which the printing has been performed inside the head case 5 is transported to the outside of the head case 5 by the transport rollers 9 and passes through the inside of the dryer 10. The dryer 10 dries the printing sheet P on which the printing has been performed. The printing sheet P dried by the dryer 10 is transported by the transport rollers 11 and then collected by the collection roller 13.

In the printer 1, drying the printing sheet P with the dryer 10 helps prevent adhesion of overlapped portions of the printing sheet P taken up in an overlapped manner and helps prevent undried liquid from rubbing against the collection roller 13.

The sensor 12 includes a position sensor, a speed sensor, or a temperature sensor. Based on information from the sensor 12, the controller 14 can determine the state of each part of the printer 1 and control each part of the printer 1.

In the printer 1 described above, a case where the printing sheet P is used as an object to be printed (i.e., a recording medium) is indicated, but the object to be printed in the printer 1 is not limited to the printing sheet P, and a rolled cloth or the like may be used as the object to be printed.

The printer 1 may transport the printing sheet P put on a conveyor belt instead of directly transporting the printing sheet P. By using the conveyor belt, the printer 1 can use a sheet of paper, a cut cloth, wood, a tile, or the like as the object to be printed.

The printer 1 may discharge a liquid containing electrically conductive particles from the liquid discharge heads 8 to print a wiring pattern or the like of an electronic device. The printer 1 may discharge a predetermined amount of a liquid chemical agent or a liquid containing the chemical agent from the liquid discharge heads 8 onto a reaction vessel or the like to produce chemicals.

The printer 1 may also include a cleaner for cleaning the liquid discharge heads 8. The cleaner cleans the liquid discharge heads 8, for example, by a wiping process or a capping process.

The wiping process is, for example, a process of wiping the surface of a portion from which a liquid is discharged, with a flexible wiper, thereby removing the liquid attached to the liquid discharge head 8.

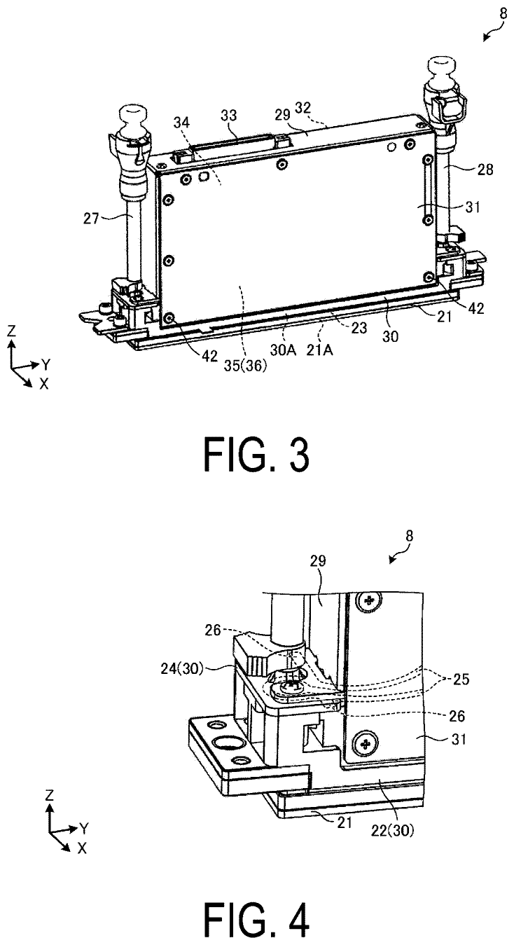

The capping process is performed as follows, for example. First, a cap is placed over the surface of the area to which the liquid is to be discharged (this is called capping). This creates a substantially hermetically sealed space between the surface of the area to which the liquid is to be discharged and the cap. Discharge of the liquid is repeated in such a hermetically sealed space. Consequently, a liquid having viscosity higher than that in a normal state, a foreign matter, or the like that has clogged a nozzle 21A (see FIG. 3) can be removed.

### Configuration of Liquid Discharge Head

A configuration of the liquid discharge head 8 according to the embodiment will be described with reference to FIG. 3. FIG. 3 is a perspective view illustrating an example of a schematic configuration of the liquid discharge head according to the embodiment.

For the sake of clarity, FIG. 3 illustrates a three-dimensional orthogonal coordinate system including the Z-axis in which a vertically upward direction is a positive direction.

Such an orthogonal coordinate system may also be presented in other drawings used in the description below. For the sake of convenience, a direction in which the nozzle 21A (see FIG. 3) is located in the liquid discharge head 8, that is, the negative direction side of the Z-axis may be referred to as “under” or “below”, and the positive direction side of the Z-axis may be referred to as “on” or “above” in the following description. In FIGS. 3 to 6, the members may be omitted or illustrated in a simplified manner.

As illustrated in FIG. 3, the liquid discharge head 8 includes a discharge member 21, a liquid supply member 30, a pressurizer 23, a first channel 27, a second channel 28, a head cover 29, heat dissipation plates 31, 32, a connector 33, a driving member (driving substrate) 34, and a connecting member (flexible substrate) 35.

The discharge member 21 is located on a bottom surface side of the liquid discharge head 8 facing the printing sheet P (see FIG. 1). The discharge member 21 includes the nozzle 21A. The nozzle 21A opens in the bottom surface of the liquid discharge head 8 and discharges the liquid supplied to the inside of the discharge member 21 to the exterior. The liquid supply member 30 is located above the discharge member 21. The liquid supply member 30 supplies the liquid to the discharge member 21. The liquid supply member 30 includes a channel 30A leading to the nozzle 21A. The liquid is supplied from the first channel 27 to the inside of the channel 30A. The details of the liquid supply member 30 will be described below.

The pressurizer 23 controls the discharge of the liquid from the discharge member 21 in response to a driving signal from a drive IC 36. The pressurizer 23 includes a piezoelectric element that is displaced by energization and a pressure chamber whose internal pressure changes in accordance with the displacement of the piezoelectric element. The pressurizer 23 controls the discharge of the liquid from the nozzle 21A included in the discharge member 21 to the outside by changing the internal pressure of the pressure chamber.

The first channel 27 supplies the liquid to the channel 30A (a channel portion 224) of the liquid supply member 30. The second channel 28 recovers the liquid from the channel 30A of the liquid supply member 30. When the ink is introduced into the liquid discharge head 8 for the first time, the introduction of the ink into the liquid discharge head 8 can be facilitated by removing air, a preservative solution, or the like inside the channel 30A from the second channel 28. In printing, the second channel 28 may be closed or may recover the ink in the channel 30A. The liquid recovered from the second channel 28 is supplied to the first channel 27, for example, through a filter (not illustrated).

The head cover 29 has a plate-like shape and is disposed covering a space located above the liquid supply member 30.

The head cover 29 can be made of an electrically conductive metal material such as aluminum. The head cover 29 may be made of, for example, an electrically conductive or insulating resin material. Thus, heat is appropriately released from the liquid discharge head 8 via the head cover 29. The thermal conductivity of the head cover 29 may be higher than that of the liquid supply member 30. Accordingly, heat conduction from the head cover 29 to the liquid supply member 30 is less likely to occur. Therefore, for example, the likelihood of occurrence of a defect in discharge performance due to a change in the properties of the liquid flowing through the liquid supply member 30 can be reduced.

The head cover 29 may be in contact with the liquid supply member 30 or may be separated from the liquid supply member 30. When the head cover 29 is separated from the liquid supply member 30, heat conduction from the head cover 29 to the liquid supply member 30 is less likely to occur, and heat conduction to the heat dissipation plates 31, 32 is promoted. Therefore, for example, the likelihood of occurrence of a defect in discharge performance due to a change in the properties of the liquid flowing through the liquid supply member 30 can be reduced.

The heat dissipation plates 31, 32 are plate-like members located along the YZ plane. The heat dissipation plates 31, 32 are located facing each other in the X-axis direction with the head cover 29 and the liquid supply member 30 interposed therebetween. The heat dissipation plates 31, 32 are fixed to the head cover 29 and the liquid supply member 30 via fixing members 42. The fixing members 42 may be, for example, screw members made of metal.

The heat dissipation plates 31, 32 can be made of, for example, the same material as the head cover 29. The heat dissipation plates 31, 32 may be made of, for example, a material having higher thermal conductivity than that of the head cover 29.

The connector 33 is electrically connected to the pressurizer 23. In response to a control signal output from the controller 14 (see FIG. 1), the connector 33 receives, for example, a driving signal for driving the piezoelectric element included in the pressurizer 23 from the outside.

The driving member 34 drives the liquid discharge head 8. The driving member 34 generates a control signal for the drive IC 36 which will be described below. The control signal for the drive IC 36 is fed to the drive IC 36 via a connecting member 35.

The connecting member 35 is located between the pressurizer 23 and the driving member 34. The connecting member 35 electrically connects the pressurizer 23 and the driving member 34. The drive IC 36 is mounted on the connecting member 35. The drive IC 36 is a so-called integrated circuit. The drive IC 36 controls the pressurizer 23 in response to a control signal sent from the driving member 34, and controls the discharge of the liquid.

### Configuration of Liquid Supply Member

A configuration of the liquid supply member 30 according to the embodiment will be described with reference to FIGS. 4 to 7. FIG. 4 is a partially enlarged perspective view of the liquid discharge head illustrated in FIG. 3.

As illustrated in FIG. 4, the liquid supply member 30 includes a channel member 22 as a first member and a lid-like member 24 as a second member. The liquid supply member 30 includes a joint 25 and a dam 26. The joint 25 and the dam 26 are located at an interface between the channel member 22 and the lid-like member 24. The liquid supply member 30 includes the channel 30A (see FIG. 3) between the channel member 22 and the lid-like member 24. The details of the joint 25 and the dam 26 will be described below.

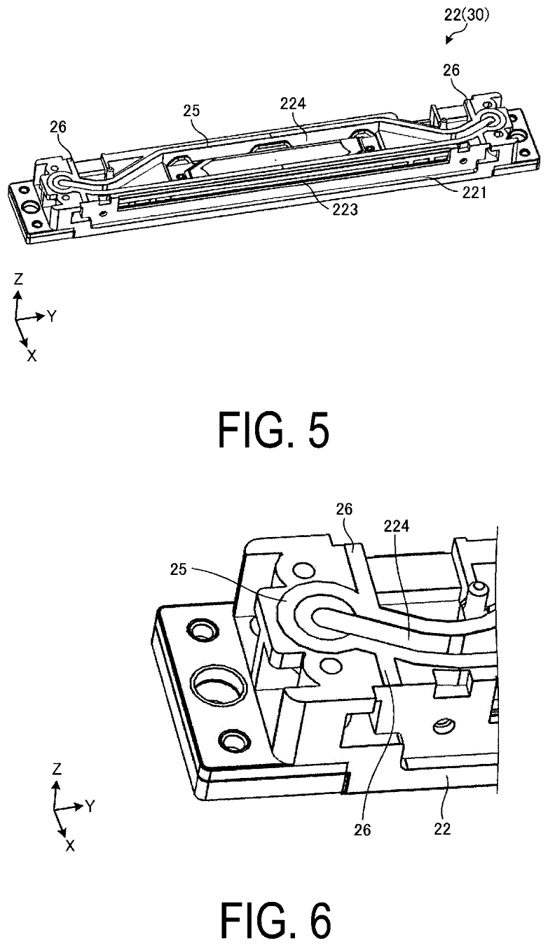

FIG. 5 is a perspective view illustrating an example of the channel member according to the embodiment. FIG. 6 is a partially enlarged perspective view of the channel member illustrated in FIG. 5. The channel member 22 illustrated in FIGS. 5 and 6 shows a state in which the lid-like member 24 is removed from the liquid supply member 30 according to the embodiment.

As illustrated in FIG. 5, the channel member 22 includes cutout portions 221, openings 223, and a channel portion 224. The cutout portions 221 and the openings 223 are located on both sides of the channel portion 224 in the X-axis direction.

Each of the cutout portions 221 is disposed so as to cut out a corresponding one of side surfaces located on both end portions of the channel member 22 in a width direction along the X-axis direction. Each of the heat dissipation plates 31, 32 (see FIG. 3) is accommodated in a corresponding one of the cutout portions 221. Accordingly, the length of the heat dissipation plates 31, 32 in the Z-axis direction can be increased compared to the head cover 29, and thus, for example, the heat dissipation of the liquid discharge head 8 can be enhanced. The heat dissipation plates 31, 32 are accommodated in the cutout portions 221, and thus, for example, an increase in the size of the liquid discharge head 8 in the X-axis direction can be avoided. The channel member 22 includes the cutout portions 221, and thus, for example, the heat dissipation plates 31, 32 are easily accommodated.

The opening 223 is located closer to the center of the channel member 22 than the cutout portion 221. The opening 223 communicates with, for example, the inside of the liquid supply member 30 that accommodates the pressurizer 23 (see FIG. 3) and the like. The connecting member 35 (see FIG. 3) is inserted through the opening 223.

The channel portion 224 is a recessed portion located at a central portion of the channel member 22 and extends in the length direction along the Y-axis direction. The channel portion 224 is sealed by the lid-like member 24 located above the channel member 22 to form the channel 30A (see FIG. 3).

The liquid supply member 30 includes the joint 25. The joint 25 is a portion at which the channel member 22 and the lid-like member 24 are joined to each other. The joint 25 is located surrounding the channel portion 224. Since the joint 25 surrounding the channel portion 224 is provided at an interface between the channel member 22 and the lid-like member 24, the liquid located between the channel member 22 and the lid-like member 24 appropriately flows inside the channel 30A (see FIG. 3).

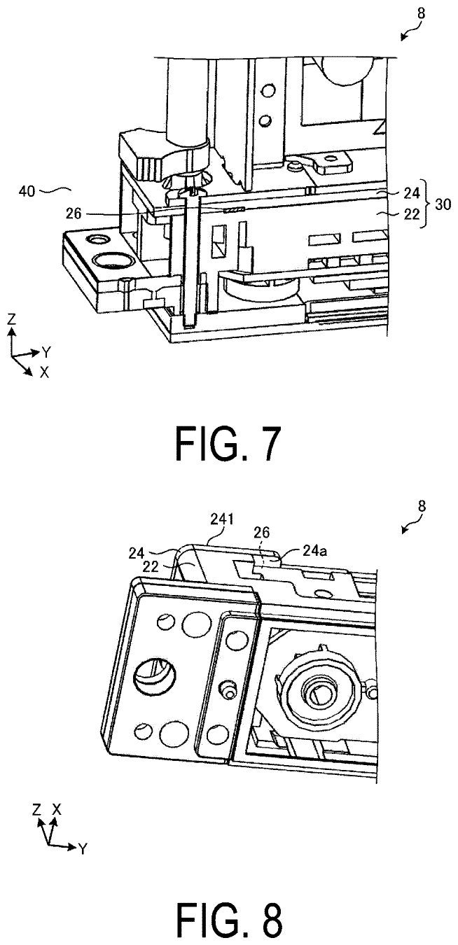

The liquid supply member 30 includes the dam 26 located at an interface between the channel member 22 and the lid-like member 24. The dam 26 is located between the opening 223 and an outside 40 (see FIG. 7). Like the joint 25, the dam 26 is a portion at which the channel member 22 and the lid-like member 24 are joined to each other. Joining mentioned here may include welding as one aspect, and specifically may be, for example, thermal welding, high-frequency welding, ultrasonic welding, or laser welding. The liquid supply member 30 is made of, for example, a resin material. Note that the liquid supply member 30 may be made of metal.

FIG. 7 is a view for explaining an example of the dam according to the embodiment. The liquid discharge head 8 illustrated in FIG. 7 corresponds to a cross-sectional view along the YZ plane of a portion at which the dam 26 is located.

For example, in the liquid supply member 30 in which the channel member 22 and the lid-like member 24 are joined to each other, an event in which ink enters a slight gap between the channel member 22 and the lid-like member 24 can inevitably occur. In such an event, when the channel member 22 and the lid-like member 24 are joined to each other only at the joint 25 surrounding the channel portion 224, the ink may avoid the joint 25, reach the opening 223, and enter the inside of the liquid supply member 30, causing a short circuit of wiring or the like. In the liquid supply member 30 according to the present embodiment, since the dam 26 is located so as to separate the opening 223 and the outside 40 from each other, even when the ink enters a gap at an end portion of the liquid supply member 30, the ink is less likely to enter the inside of the liquid supply member 30. Accordingly, a short circuit of wiring or the like in the inside of the liquid supply member 30 is less likely to occur, and thus the reliability of the liquid supply member 30 is increased.

The dam 26 will be further described. As illustrated in FIGS. 4 and 5, the dam 26 may extend from the joint 25 in a direction intersecting the joint 25. More specifically, the dam 26 may extend from the joint 25 in the width direction of the channel member 22. Accordingly, the joint strength between the channel member 22 and the lid-like member 24 is increased.

The dam 26 may lie up to an edge of the channel member 22 so as to extend away from the channel portion 224. Accordingly, even when the ink enters a gap at an end portion of the liquid supply member 30, the ink is further less likely to enter the inside of the liquid supply member 30. As a result, a short circuit of wiring or the like in the liquid supply member 30 is less likely to occur, and thus the reliability of the liquid supply member 30 is further increased.

As illustrated in FIG. 4, the dam 26 may be located on an outer side relative to the head cover 29. In other words, the dam 26 may be located closer to an end portion than the head cover 29 is. More specifically, the dam 26 may be located closer to an end portion of the liquid supply member 30 in the length direction than the head cover 29 is. Accordingly, the liquid discharge head 8 into which the ink is less likely to enter can be obtained, and thus the reliability of the liquid discharge head 8 is increased.

As illustrated in FIG. 4, the dam 26 may be located on an outer side relative to each of the heat dissipation plates 31, 32 (see FIG. 3). In other words, the dam 26 may be located closer to an end portion than each of the heat dissipation plates 31, 32 (see FIG. 3) is. More specifically, the dam 26 may be located closer to an end portion of the liquid supply member 30 in the width direction than each of the heat dissipation plates 31, 32 is. Accordingly, the liquid discharge head 8 into which the ink is less likely to enter can be obtained, and thus the reliability of the liquid discharge head 8 is increased.

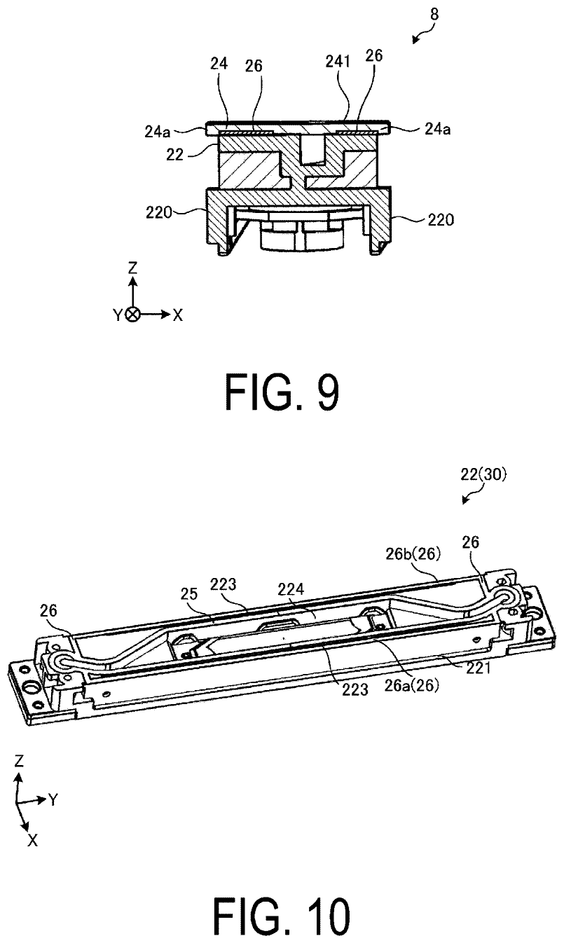

An example of the liquid supply member 30 according to the embodiment will be described with reference to FIGS. 8 and 9. Here, a case where the liquid supply member 30 is a resin member joined by laser welding will be described as an example.

FIG. 8 is a perspective view illustrating an example of the liquid supply member according to the embodiment. FIG. 9 is a cross-sectional view for explaining the lid-like member according to the embodiment.

The material of the channel member 22 as the first member may be, for example, a light-absorbing resin that absorbs laser light. The material of the lid-like member 24 as the second member may be, for example, a light-transmissive resin that transmits laser light. A first surface 241 of the lid-like member 24 located on a side opposite to the channel member 22 is irradiated with laser light, whereby the joint 25 (see FIG. 4) and the dam 26 are formed at the interface between the channel member 22 and the lid-like member 24.

The lid-like member 24 may include a first portion 24a covering the periphery of an edge of the channel member 22. As illustrated in FIG. 9, the first portions 24a is located outside both ends of the channel member 22 along the X-axis direction. When an end portion of the channel member 22 is irradiated with the laser, the channel member 22 may swell and protrude from the edge of the channel member 22. Even in such a case, by providing the first portion 24a, the likelihood that the light-absorbing resin protruding from the edge of the channel member 22 is directly hit by the laser and, for example, is overheated can be reduced.

In the lid-like member 24, the first portion 24a located on an outer side relative to the dam 26 may be larger in surface roughness than another portion of the lid-like member 24 as the second member. For example, the first surface 241 of the lid-like member 24 located at the first portion 24a may be larger in surface roughness than another portion of the first surface 241. Accordingly, the intensity of the laser light transmitted through the first portion 24a is reduced, and overheating of the light-absorbing resin protruding from the edge of the channel member 22 can be reduced.

Note that the surface roughness refers to a surface roughness measured in accordance with JIS B 0601 (2013), for example. A contact type surface roughness gauge or a non-contact type surface roughness gauge may be used for the measurement. As measurement conditions, for example, a measurement length is set to 0.4 mm, a cutoff value is set to 0.08 mm, a spot diameter is set to 0.4 um, and a scanning speed is set to 1 mm/sec. Note that the measurement conditions may be set as appropriate.

Although an example in which the first surface 241 of the lid-like member 24 has a larger surface roughness has been described, the surface of the lid-like member 24 opposite to the first surface 241 may have a larger surface roughness.

As illustrated in FIG. 9, the dam 26 may be located in a region which is an edge of the channel member 22 and forms a step. That is, the dam 26 may be located on the inner side of a side surface 220 of the channel member 22. Accordingly, even when the lid-like member 24 includes the first portion 24a, the size of the liquid supply member 30 is less likely to increase.

### Other Embodiments

FIG. 10 is a perspective view illustrating another example of the channel member according to the embodiment. As illustrated in FIG. 10, the dam 26 may be located surrounding the openings 223. The dam 26 may further include dams 26a, 26b located opposite to the joint 25 with the openings 223 between the joint 25 and each of the dams 26a, 26b. Accordingly, since the peripheries of the openings 223 are sealed, even when the ink enters a gap at an end portion of the liquid supply member 30, the ink is further less likely to enter the inside of the liquid supply member 30. As a result, a short circuit of wiring or the like in the liquid supply member 30 is less likely to occur, and thus the reliability of the liquid supply member 30 is further increased.

### Other Embodiments

The liquid discharge head 8 includes the heat dissipation plates 31, 32 as described in the above embodiment, but may include only one of the heat dissipation plates 31, 32. In that case, the channel member 22 may include only the cutout portion 221 corresponding to the heat dissipation plate included in the liquid discharge head 8.

The channel member 22 includes two openings 223 as described in the above embodiment, but may include only one opening 223. In that case, the number of the connecting members 35 inserted into the opening 223 can be one corresponding to the one opening 223.

The liquid supply member 30 supplies the ink to the discharge member 21 as described in the above embodiment, but the liquid supply member 30 may recover the ink from the discharge member 21. In that case, the liquid supply member 30 is provided with two separate channels, that is, a supply channel for supplying the ink fed from the first channel 27 to the discharge member 21 and a recovery channel for recovering, from the discharge member 21, the ink that has not been discharged and sending the ink to the second channel 28. The supply channel may have, for example, substantially the same structure as the channel 30A (channel portion 224) of the above-described embodiment, but a channel directly connected to the second channel 28 is not necessarily provided. In FIG. 5, the supply channel is not necessarily provided with a portion extending in the positive Y-axis direction from a central portion of the channel portion 224 in the Y-axis direction. Like the channel 30A, the recovery channel may be formed by closing a recessed portion provided in the channel member 22 with the lid-like member 24. In that case, the recessed portion leading to the second channel 28 serving as the recovery channel may have a structure that is the same as or similar to the structure of the portion extending in the positive Y-axis direction from the central portion of the channel portion 224 in the Y-axis direction in FIG. 5. The joint 25 may be provided at the periphery of the recessed portion of the channel member 22 serving as the recovery channel, and the dam 26 may be provided extending from the joint 25 as in FIG. 5. The liquid recovered from the second channel 28 is supplied to the first channel 27, for example, through a filter (not illustrated).

As described above, the liquid supply member 30 according to the embodiment includes the first member (for example, the channel member 22), the second member (for example, the lid-like member 24), the channel 30A, the joint 25, the openings 223, and the dam 26. The channel 30A is located between the first member and the second member. The joint 25 is located at an interface between the first member and the second member and surrounds the channel 30A. The openings 223 communicate with the inside of the liquid supply member. The dam 26 is located between each of the openings 223 and the outside 40. As a result, the liquid supply member 30 of the embodiment can have high reliability.

Further effects and variations can be readily derived by those skilled in the art. Thus, a wide variety of aspects of the present invention are not limited to the specific details and representative embodiments represented and described above. Accordingly, various changes can be made without departing from the spirit or scope of the general inventive concepts defined by the appended claims and their equivalents.

### REFERENCE SIGNS

1 Printer
8 Liquid discharge head
14 Controller
21 Discharge member
21A Nozzle
22 Channel member
23 Pressurizer
24 Lid-like member
25 Joint
26 Dam
29 Head cover
30 Liquid supply member
30A Channel
31, 32 Heat dissipation plate
33 Connector
34 Driving member (driving substrate)
35 Connecting member (flexible substrate)
36 Drive IC
223 Opening

1. A liquid supply member comprising:
a first member;
a second member;
a channel located between the first member and the second member;
a joint located at an interface between the first member and the second member, the joint surrounding the channel;
an opening communicating with an inside of the liquid supply member; and
a dam located between the opening and the outside.

2. The liquid supply member according to claim 1, wherein the dam extends from the joint in a direction intersecting the joint.

3. The liquid supply member according to claim 1, wherein the dam lies up to an edge of the first member.

4. The liquid supply member according to claim 1, wherein
the dam is a laser-welded portion, and
the second member comprises a first portion covering a periphery of an edge of the first member.

5. The liquid supply member according to claim 4, wherein the first portion located on an outer side relative to the dam is larger in surface roughness than another portion of the second member.

6. The liquid supply member according to claim 1, wherein the dam surrounds a periphery of the opening.

7. A liquid discharge head comprising:
the liquid supply member according to claim 1;
a pressurizing member;
a driving member configured to drive the pressurizing member; and
a head cover covering the driving member,
wherein the dam is located on an outer side relative to the head cover.

8. The liquid discharge head according to claim 7, wherein the opening in the liquid supply member communicates with the pressurizing member.

9. A liquid discharge head comprising:
the liquid supply member according to claim 1;
a pressurizing member;
a drive IC configured to supply a signal to the pressurizing member; and
a heat dissipation plate configured to dissipate heat of the drive IC to the outside, wherein the dam is located on an outer side relative to the heat dissipation plate.

10. The liquid discharge head according to claim 9, wherein the opening in the liquid supply member communicates with the pressurizing member.

11. A recording device comprising the liquid discharge head according to claim 1.
